(19) United States
(12) Patent Application Publication
(10) Pub. No.: US 2003/0045423 A1
(43) Pub. Date: Mar. 6, 2003

(54) Supported rhodium-lanthanide based catalysts and process for producing synthesis gas

(75) Inventors: Hasan Dindi, Wilmington, DE (US); William H. Manogue, Newark, DE (US); Norman Herron, Newark, DE (US); Tianyan Niu, Ponca City, OK (US); Daxiang Wang, Ponca City, OK (US); David M. Minahan, Ponca City, OK (US)

Correspondence Address: DAVID W. WESTPHAL, CONOCO PHILLIPS, P.O. BOX 4783, HOUSTON, TX, 77210-4783, US

(73) Assignee: Conoco Inc., Houston, TX

(21) Appl. No.: 10/162,056

(22) Filed: Jun. 4, 2002

Related U.S. Application Data
(60) Provisional application No. 60/295,913, filed on Jun. 4, 2001.

(51) Int. Cl. C01B 3/26

(52) U.S. Cl. 502/302; 423/651

(57) ABSTRACT

A family of supported hexagonal phase mixed metal oxide catalysts are disclosed that have the general formula M_{2.5}LnRh₆O₁₃ (expressed as atomic ratios), wherein M refers to Group II elements such as Mg, Ca, Ba, Sr and Be or a Group VIII transition metal that can exist in a +2 oxidation state, such as Ti, V, Mn, Fe, Co, Ni, Cu, Zn, Nb, Pd, Cd and Ta. Ln refers to the rare earth lanthanide group of elements, such as La, Yb, Sm and Ce. This family of catalysts demonstrate unexpected activity for efficiently catalyzing the net partial oxidation of methane in a short contact time reactor, with high selectivities for H₂ product.

### CROSS-REFERENCE TO RELATED APPLICATIONS

This application claims the benefit under 35 U.S.C. §119(e) of U.S. Provisional Patent Application No. 60/295,913 filed Jun. 4, 2001, the disclosure of which is incorporated herein by reference.

### BACKGROUND OF THE INVENTION

1. Field of the Invention

The present invention generally relates to mixed metal oxide catalysts, particularly rhodium-lanthanide based catalysts, and processes employing such catalysts for the catalytic partial oxidation of light hydrocarbons (e.g., natural gas) to produce synthesis gas.

2. Description of Related Art

Large quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or syngas). In a second step, the syngas is converted to hydrocarbons, for example, using the Fischer-Tropsch process to provide fuels that boil in the middle distillate range, such as kerosene and diesel fuel, and hydrocarbon waxes.

Current industrial use of methane as a chemical feedstock proceeds by the initial conversion of methane to carbon monoxide and hydrogen by either steam reforming, which is the most widespread process, or by dry reforming. Steam reforming currently is the major process used commercially for the conversion of methane to synthesis gas, proceeding according to Equation 1.

CH₄+H₂O [symbol] CO+3H₂ (1)

Although steam reforming has been practiced for over five decades, efforts to improve the energy efficiency and reduce the capital investment required for this technology continue.

The catalytic partial oxidation (CPOX) of hydrocarbons, e.g., natural gas or methane to syngas is also a process known in the art. While currently limited as an industrial process, partial oxidation has recently attracted much attention due to significant inherent advantages, such as the fact that significant heat is released during the process, in contrast to steam reforming processes.

In catalytic partial oxidation, natural gas is mixed with air, oxygen-enriched air, or oxygen, and introduced to a catalyst at elevated temperature and pressure. The partial oxidation of methane yields a syngas mixture with a H₂:CO ratio of 2:1, as shown in Equation 2.

CH₄+1/2 O₂ [symbol] CO+2H₂ (2)

This ratio is more useful than the H₂:CO ratio from steam reforming for the downstream conversion of the syngas to chemicals such as methanol and to fuels. The partial oxidation is also exothermic, while the steam reforming reaction is strongly endothermic. Furthermore, oxidation reactions are typically much faster than reforming reactions. This allows the use of much smaller reactors for catalytic partial oxidation processes. The syngas in turn may be converted to hydrocarbon products, for example, fuels boiling in the middle distillate range, such as kerosene and diesel fuel, and hydrocarbon waxes by processes such as the Fischer-Tropsch synthesis.

The selectivities of catalytic partial oxidation to the desired products, carbon monoxide and hydrogen, are controlled by several factors, but one of the most important of these factors is the choice of catalyst composition. Difficulties have arisen in the prior art in making such a choice economical. Typically, catalyst compositions have included precious metals and/or rare earths. The large volumes of expensive catalysts needed by some prior art catalytic partial oxidation processes have placed these processes generally outside the limits of economic justification.

For successful operation at commercial scale, the catalytic partial oxidation process must be able to achieve a high conversion of the methane feedstock at high gas hourly space velocities, and the selectivity of the process to the desired products of carbon monoxide and hydrogen must be high. Such high conversion and selectivity must be achieved without detrimental effects to the catalyst, such as the formation of carbon deposits (“coke”) on the catalyst, which severely reduces catalyst performance. Accordingly, substantial effort has been devoted in the art to the development of catalysts allowing commercial performance without coke formation.

An attempt at synthesis gas production by catalytic partial oxidation to overcome some of the disadvantages and costs typical of steam reforming is described in European Patent No. EP303,438, entitled “Production of Methanol from Hydrocarbonaceous Feedstock.” Certain high surface area monoliths of cordierite (MgO/Al₂O₃/SiO₂), Mn/MgO cordierite (Mn—MgO/Al₂O₃/SiO₂), mullite (Al₂O₃/SiO₂), mullite aluminum titanate (Al₂O₃/SiO₂ (Al,Fe)₂O₃/TiO₂), zirconia spinel (ZrO₂/MgO/Al₂O₃), spinel (MgO/Al₂O₃) and high nickel alloys are suggested as catalysts for the process. The monoliths may be coated with metals or metal oxides that have activity as oxidation catalysts, e.g., Pd, Pt, Rh, Ir, Os, Ru, Ni, Cr, Co, Ce, La, and mixtures thereof. Other suggested coating metals are noble metals and metals of groups IA, IIA, III, IV, VB, VIB, or VIIB of the periodic table of the elements. Spinels are well known crystal structures and have been described in the literature; for example, in A. F. Wells, “Structural Inorganic Chemistry,” Claredon Press, Oxford, 1975, p. 489.

A number of process regimes have been proposed for the production of syngas via catalyzed partial oxidation reactions. For example, U.S. Pat No. 5,648,582 discloses a process for the catalytic partial oxidation of a feed gas mixture consisting essentially of methane. The methane-containing feed gas mixture and an oxygen-containing gas are passed over an alumina foam supported metal catalyst at space velocities of 120,000 h⁻¹ to 12,000,000 h⁻¹. The catalytic metals exemplified are rhodium and platinum, at a loading of about 10 wt %.

Certain catalysts containing Group VIII metals such as nickel or rhodium on a variety of supports have been described. For example, V. R. Choudhary et al. (“Oxidative Conversion of Methane to Syngas over Nickel Supported on Low Surface Area Catalyst Porous Carriers Precoated with Alkaline and Rare Earth Oxides,” ((1997) J. Catal., 172: 281-293) disclose the partial oxidation of methane to syngas at contact times of 4.8 ms (at STP) over supported nickel catalysts at 700 and 800° C. The catalysts were prepared by depositing NiO—MgO on different commercial low surface area porous catalyst carriers consisting of refractory compounds such as SiO₂, Al₂O₃, SiC, ZrO₂ and HfO₂. The catalysts were also prepared by depositing NiO on the catalyst carriers with different alkaline and rare earth oxides such as MgO, CaO, SrO, BaO, Sm₂O₃ and Yb₂O₃.

U.S. Pat. No. 5,149,464 describes a method for selectively converting methane to syngas at 650° C. to 950° C. by contacting the methane/oxygen mixture with a solid catalyst comprising a supported d-Block transition metal, transition metal oxide, or a compound of the formula MₓM′_{y}O_{z} wherein M is Mg, B, Al, Ga, Si, Ti, Zr, Hf or a lanthanide, M′ is a d-block transition metal, and each of the ratios x/z and y/z and (x+y)/z is independently from 0.1 to 8; or b) an oxide of a d-block transition metal; or c) a d-block transition metal on a refractory support; or d) a catalyst formed by heating a) or b) under the conditions of the reaction or under non-oxidizing conditions. In the mixed metal oxides, the ratio of x to y is not considered critical.

The partial oxidation of methane to synthesis gas using various transition metal catalysts under a range of conditions has been described by Vernon, D. F. et al. ((1990) Catalysis Letters 6:181-186). European Pat. App. Pub. No. 640561 discloses a catalyst for the catalytic partial oxidation of hydrocarbons comprising a Group VIII metal on a refractory oxide having at least two cations.

U.S. Pat. No. 5,447,705 discloses an oxidation catalyst having a perovskite crystalline structure and the general composition: LnₓA_{1-y}B_{y}O₃, wherein Ln is a member of the lanthanide series of elements, and A and B are different metals chosen from Group IVb, Vb, VIb, VIIb or VIII of the Periodic Table of the Elements. The catalyst is said to have activity for the partial oxidation of methane.

U.S. Pat. No. 5,105,044 discloses a process for synthesizing hydrocarbons having at least two carbon atoms by contacting a mixture of methane and oxygen with a spinel oxide catalyst of the formula AB₂O₄, where A is Li, Mg, Na, Ca, V, Mo, Mn, Fe, Co, Ni, Cu, Zn, Ge, Cd or Sn and B is Na, Al, Ti, V, Cr, Mn, Fe, Co, Ni, Zn, Ga, Ge, Rh, Ag or In, A and B being different elements.

U.S. Pat. No. 5,653,774 discloses a spinel catalyst of the formula M²⁺M₂³⁺O₄ where M²⁺ at least one member of a group consisting of Mg²⁺, Zn²⁺, Ni²⁺, Fe²⁺, Cu²⁺, Co²⁺, Mn²⁺, Pd²⁺ and Pt²⁺, and M³⁺ is at least one member of a group consisting of Al³⁺, B³⁺, Cr³⁺, Fe³⁺, Ga³⁺, In³⁺, La⁺³, Ni³⁺, Co³⁺, Mn³⁰, Rh³⁺, Ti³⁺ and V³⁺ ions, for the preparation of synthesis gas from a hydrocarbyl compound. The catalyst is prepared by heating hydrotalcite-like compositions having the general formula [M²⁺₍₁₋ₓ₎Mₓ³⁺(OH₂)]^{x+}(A_{x/n}ⁿ⁻¹).mH₂O.

U.S. Pat. No. 5,238,898 describes a process for upgrading methane to higher hydrocarbons using spinel oxide catalysts such as MgMn₂O₄ or CaMn₂O₄, modified with an alkali metal such as Li or Na.

British Pat. No. GB2247465 describes certain catalysts comprising platinum group metals supported on inorganic compounds such as oxides and/or spinels of aluminum, magnesium, zirconium, silicon, cerium and/or lanthanum, and combinations thereof, together with an alkaline metal in some cases. These catalysts are said to be active for producing synthesis gas from methane by means of reforming and combustion reactions, optionally in the presence of steam.

U.S. Pat. No. 5,654, 491 describes a process for catalytic partial oxidation of a hydrocarbon gas comprising one or more normal (C₂-C₄) alkanes with an oxygen-containing gas. The catalyst structure, comprising a Group VIII metal, has a transparency of at least about 40% and the feed gas mixture is passed through the catalyst structure at a rate such that the superficial contact time of the feed gas mixture with the catalyst structure is no greater than about 1000 microseconds to produce partial oxidation products.

Yang HY et al. (1999) J. Catalysis 186:181-187) describe the partial oxidation of methane over MgO- and SiO₂- supported Rh catalysts. It was considered likely that the strong interactions between rhodium and magnesium oxide were responsible for the high stability of the Rh/MgO catalyst. Ruckenstein E et al. (2000) App. Catalysis 198:33-41) also describe the effect of the precursor of magnesium oxide on the partial oxidation of methane over the MgO-supported Rh catalysts. It was said that the strong interactions between rhodium and the MgO support delayed sintering of the metal and the resulting deactivation of the catalyst.

One disadvantage of many of the existing catalytic hydrocarbon conversion methods is the need to include steam in the feed mixture to suppress coke formation on the catalyst. Another drawback of some of the existing processes is that the catalysts that are employed often result in the production of significant quantities of carbon dioxide, steam, and C₂₊ hydrocarbons. Although significant advances in the field of synthesis gas generation have been provided by various of the prior art catalysts, there still exists a need for better catalysts for the catalytic partial oxidation of hydrocarbons, particularly methane, which are capable of providing a high level of activity and selectivity for hydrogen and carbon monoxide products, under operating conditions of high gas space velocity, elevated pressure and high temperature.

### SUMMARY OF PREFERRED EMBODIMENTS

The present invention provides catalysts and a syngas production process that offer good hydrocarbon conversion levels, relatively lower reaction temperatures than conventional partial oxidation syngas processes, and offer enhanced selectivity for H₂ product. Although various spinels and perovskites have been described as good syngas catalysts, the presently-disclosed unique family of hexagonal phase M_{2.5}LnRh₆O₁₃ mixed metal oxide catalysts have never before been recognized as good syngas catalysts. These stable mixed metal oxide catalysts are highly active for catalyzing the partial oxidation of methane to synthesis gas at very high selectivities for H₂ product and at lower reaction temperatures than is typical for CPOX processes, while maintaining good reaction activity (i.e., conversion of the hydrocarbon). Also provided are methods of making the new catalysts. The present invention further provides a process for preparing synthesis gas using these catalysts for the net catalytic partial oxidation of light hydrocarbons having a low boiling point (e.g. C₁-C₅ hydrocarbons, particularly methane, or methane containing feeds). One advantage of the new process is that the new M_{2.5}LnRh₆O₁₃ mixed metal oxide catalysts are stable under CPOX reaction conditions, retaining a high level of activity and selectivity to hydrogen and carbon monoxide under conditions of high gas space velocity and elevate pressure. Moreover, these catalysts operate at relatively lower temperatures than many other syngas catalysts. The new processes of the invention are particularly useful for converting gas from naturally occurring reserves of methane which contain carbon dioxide. Another advantage of the new catalysts and processes is that they are economically feasible for use in commercial-scale conditions.

Accordingly, certain embodiments of the invention provide a syngas catalyst that comprises a hexagonal phase mixed metal oxide having the general formula (expressed as atomic ratios) M_{2.5}LnRh₆O₁₃. M is a Group II element of the periodic table or a Group VIII transition metal that is capable of existing in a +2 oxidation state in the M_{2.5}LnRh₆O₁₃ structure, such as Ti, V, Mn, Fe, Co, Ni, Cu, Zn, Nb, Pd, Cd and Ta. Ln is a member of the lanthanide series of elements. In some embodiments the Group II element is Be, Mg, Ca, Sr or Ba. In some embodiments the Group VIII metal is Zn or Cu. In some embodiments Ln is La, Yb, Sm or Ce. In preferred embodiments the mixed metal oxide is deposited on a refractory support such as ZrO₂, PSZ, YTA, alumina, TiO₂ and cordierite. In one embodiment the catalyst is Mg_{2.5}LaRh₆O₁₃ deposited on a refractory support. In another embodiment the catalyst is Mg_{2.5}YbRh₆O₁₃ deposited on a refractory support.

In certain embodiments the catalyst has a tortuous-path three-dimensional structure, and in some embodiments the three-dimensional structure is a monolith, gauze, honeycomb, foam, pellet, powder, bead, sphere or granule, suitable for use in a fixed bed, moving or fluidized bed reactor.

In another embodiment of the present invention a method of making a supported syngas catalyst is provided. The resulting catalyst is active for catalyzing the net partial oxidation of C₁-C₅ hydrocarbons (e.g., methane) in the presence of oxygen to CO and H₂. The catalyst comprises a hexagonal phase mixed metal oxide having the general formula (expressed as atomic ratios) M_{2.5}LnRh₆O₁₃. M is a Group II element of the periodic table of the elements or a Group VIII transition metal that is capable of existing in a +2 oxidation state in the M_{2.5}LnRh₆O₁₃ structure. Ln is a rare earth element. In some embodiments the Group II element is Mg, Ca, Ba or Sr. In some embodiments the Group VIII metal is Zn or Cu. In some embodiments Ln is La, Yb, Sm or Ce. In preferred embodiments the mixed metal oxide is deposited on a refractory support such as ZrO₂, PSZ, YTA, alumina, TiO₂ and cordierite. In one embodiment the catalyst is Mg_{2.5}LaRh₆O₁₃ deposited on a refractory support. In another embodiment the catalyst is Mg_{2.5}YbRh₆O₁₃ deposited on a refractory support.

According to certain embodiments the method includes depositing an oxidizable, and/or thermally decomposable rhodium salt on a refractory support material, depositing an oxidizable salt of a lanthanide element on the refractory support material. and depositing on the refractory support material an oxidizable/thermally decomposable salt of a Group II or a Group VIII transition metals that is capable of existing in a +2 oxidation state, to yield a coated support material. The oxidizable/thermally decomposable salts are preferably deposited on the support together or simultaneously. The method further comprises calcining the coated support material in an oxidizing atmosphere such that the oxidizable/thermally decomposable salts become converted to a hexagonal oxide phase Mg_{2.5}LaRh₆O₁₃ structure. The hexagonal oxide phase may be confirmed by X-ray diffraction analysis. The method may further comprise cooling the coated support material while flushing with an inert gas, and may also include calcining the coated support material in a non-oxidizing atmosphere before beginning syngas production. In certain alternative embodiments the coated support material, which may be in the form of particles or powder, is extruded or formed into a three-dimensional structure such as a foam monolith. In still other alternative embodiments the catalyst is in the form of a bed of discrete or divided structures such as granules or spheres.

According to still another embodiment of the invention, a method of producing synthesis gas is provided. The method includes mixing a C₁-C₅ hydrocarbon-containing feedstock and an O₂-containing feedstock to provide a reactant gas mixture. The method further includes contacting the reactant gas mixture with a catalytically effective amount of an above-described supported catalyst comprising a hexagonal phase mixed metal oxide having the general formula (expressed as atomic ratios) M_{2.5}LnRh₆O₁₃. The method also includes maintaining the catalyst and the reactant gas mixture at partial oxidation promoting conditions of temperature, flow rate, and concentration of reactant gases while contacting the catalyst with the reactant gas mixture. Preferably the contacting does not exceed about 200 milliseconds, more preferably under 50 milliseconds, and still more preferably 20 milliseconds or less. A contact time of 10 milliseconds or less is highly preferred. As used herein, the term “about” or “approximately,” when preceding a numerical value, has its usual meaning and also includes the range of normal measurement variations that is customary with laboratory instruments that are commonly used in this field of endeavor (e.g., weight, temperature or pressure measuring devices), preferably within ±10% of the stated numerical value. The terms “discrete” or “divided” structures or units refer to catalyst devices or supports in the form of divided materials such as granules, beads, pills, pellets, cylinders, trilobes, extrudates, spheres or other rounded shapes, or another manufactured configuration. Alternatively, the divided material may be in the form of irregularly shaped particles. Preferably at least a majority (i.e., >50%) of the particles or distinct structures have a maximum characteristic length (i.e., longest dimension) of less than ten millimeters, preferably less than five millimeters.

The term “monolith” refers to any singular piece of material of continuous manufacture such as solid pieces of metal or metal oxide or foam materials or honeycomb structures. Two or more such catalyst monoliths may be stacked in the catalyst zone of the reactor if desired. In any case, the catalyst device, system or bed has sufficient porosity, or sufficiently low resistance to gas flow, to permit a stream of said reactant gas mixture to pass over the catalyst at a gas hourly space velocity (GHSV) of at least about 20,000 h⁻¹, preferably at least 100,000 h⁻¹, when the reactor is operated to produce synthesis gas.

In certain embodiments the method includes maintaining a catalyst temperature not exceeding 2,000° C. (e.g., about 600-1,200° C., preferably about 700-1,100° C.) during the contacting. In certain embodiments the method includes maintaining the reactant gas mixture at a pressure of about 100-12,500 kPa, preferably about 130-10,000 kPa, during the contacting.

In certain embodiments of the syngas production method of the present invention, the method includes mixing a methane-containing feedstock and an oxygen-containing feedstock to provide a reactant gas mixture having a carbon:oxygen molar ratio of about 1.5:1 to about 3.3:1, preferably about 2:1. In some embodiments the reactant gas feed also contains steam and/or CO₂.

In certain embodiments of the syngas production method, the C₁-C₅ hydrocarbon comprises at least about 50% methane by volume. In some embodiments the reactant gas mixture is preheated before contacting the catalyst, for example, up to about 750° C. In preferred embodiments of the syngas production method the reactant gas mixture is passed over the catalyst at a gas hourly space velocity of about 20,000 to about 100,000,000 h⁻¹ (vol/vol), and preferably in the range of about 100,000-25,000,000 hr⁻¹.

Some embodiments of the syngas production method include retaining the catalyst in a fixed bed reaction zone, and in other embodiments the catalyst is maintained in a moving bed reaction zone. These and other embodiments, features and advantages of the present invention will become apparent with reference to the following description.

### DETAILED DESCRIPTION OF PREFERRED EMBODIMENTS

The term “catalytic partial oxidation” when used in the context of the present syngas production methods, in addition to its usual meaning, can also refer to a net partial oxidation process, in which hydrocarbons (comprising mainly methane) and oxygen are supplied as reactants and the resulting product stream is predominantly the partial oxidation products CO and H₂, rather than the complete oxidation products CO₂ and H₂O. For example, employing a methane feed, the preferred catalysts serve in a short contact time process, which is described in more detail below, to yield a product gas mixture containing H₂ and CO in a molar ratio of approximately 2:1. Other oxidation reactions may also occur in the reactor to a lesser or minor extent such as combustion and steam reforming to produce a net product of syngas. As shown in Equation (2), the partial oxidation of methane yields H₂ and CO in a molar ratio of 2:1.

New hexagonal phase Rh-lanthanide based mixed metal catalysts having the general stoichiometric formula M_{2.5}LnRh₆O₁₃ have been developed as improved catalysts for the net catalytic partial oxidation of light alkanes in the presence of oxygen to form syngas. M is a Group II element of the periodic table (i.e., Be, Mg, Ca, Sr, or Ba) or a Group VIII transition metal that is capable of existing in a 2+oxidation state (i.e., Ti, V, Mn, Fe, Co, Ni, Cu, Zn, Nb, Pd, Cd and Ta). Ln is a member of the lanthanide series of elements. Preferred Group II element are Mg, Ca, Ba and Sr. Preferred Group VIII metals are Zn and Cu. Preferred lanthanides are La, Yb, Sm and Ce. The M_{2.5}LnRh₆O₁₃ oxides are preferably carried on a refractory support such as PSZ (e.g., magnesium stabilized zirconia, zirconia stabilized alumina, yttrium stabilized zirconia, calcium stabilized zirconia), yttrium toughened alumina (YTA), alumina, TiO₂, cordierite, ZrO₂, and the like. Other suitable support materials include zirconia-tetra-alumina (ZTA, 20% ZrO₂80% Al₂O₃), oxide-bonded silicon carbide (OBSiC, 50% SiC 40% Al₂O₃, 10% SiO₂), mullite (63% Al₂O₃ 37% SiO₂), lithium aluminum silicate (LAS, 4% LiO₂ 29% Al₂O₃, 67% SiO₂), sialon (silicon aluminum oxynitride), titanates such as SrTiO₃, fused silica, magnesia, yttrium aluminum garnet (YAG), and boron nitride.

As shown in the data presented below, the representative new M2.5LnRh6O13 catalysts are highly active for converting methane to CO and H2 products, and demonstrate good selectivities for CO and H2 products. The supported catalysts are prepared as described in the following examples and utilizing techniques known to those skilled in the art, such as impregnation, wash coating, adsorption, ion exchange, precipitation, co-precipitation, deposition precipitation, sol-gel method, xerogel or aerogel formation, freeze-drying, spray drying, spray roasting, slurry dip-coating, microwave heating, or using other suitable techniques that are known in the art. Preferred techniques are impregnation and wash coating of a porous ceramic monolith. Alternatively, the hexagonal phase M2.5LnRh6O13 oxide, with or without addition of a particulate ceramic support composition, may be extruded or otherwise formed into a three-dimensional structure such as a honeycomb, foam, other suitable tortuous-path structure or formed into a divided catalyst structure such as granules, beads, pills, pellets, cylinders, trilobes, extrudates, spheres, or coated onto a divided support. The formation of the supported catalyst is preferably followed by drying and calcining, or thermally treating the supported materials under reaction (i.e., non-oxidizing) conditions; in certain situations it may be preferable to perform this thermal treatment in situ in the reactor under reaction conditions.

Any suitable reaction regime may be applied in order to contact the hydrocarbon/oxygen reactants with the catalyst to produce synthesis gas. One suitable regime is a fixed bed reaction regime, in which the catalyst is retained within a reaction zone in a fixed arrangement.

Test Procedure

Catalytic partial oxidation reactions were conducted with a conventional flow apparatus using a 19 mm O.D.×13 mm I.D. quartz reactor with a M_{2.5}LnRh₆O₁₃ hexagonal phase catalyst supported on a monolith (12 mm O.D.) held between two 5 mm×12 mm alpha-alumina foam disks. The supported catalyst and the disks were wrapped with an alumina cloth to obtain a single cylinder of 13 mm diameter and about 15 mm height. Two band heaters were fitted around the quartz reactor. The band heaters were used to supply thermal energy to light off the reaction and to preheat the feed gases. After light off, the band heaters were turned off and the reaction proceeded autothermally. Two Type S thermocouples, one at each end of the gauze stack, were used to monitor the reaction temperature.

The methane-containing and oxygen gases were mixed at room temperature and the mixed gas was fed to the reactor with or without preheating. The product gas mixture was analyzed for CH₄, O₂, CO, H₂, CO₂ and N₂ using a gas chromatograph equipped with a thermal conductivity detector.

GHSV is gas hourly space velocity, i.e., liters of gas (measured at atmospheric pressure and 23° C.) fed per hour per liter of catalyst. The GHSV is generally calculated as follows:

GHSV=Fₜₒₜ/V_{cat}

where Fₜₒₜ is the total reactant volumetric flowrate at standard conditions in cm³/sec, and V_{cat} is the volume of the catalyst reaction zone in cm³. For example, the volume of the catalyst reaction zone is simply the volume of the cylinder (e.g., 12 mm in diameter×10 mm in length, or 1.2 cm³). Thus, at a flowrate of 1,389 cm³/min, the GHSV is calculated as follows:

GHSV(h⁻¹)−(1389 cm³/min)/(1.2 cm³)×(60 min/h)−100,000 h⁻¹.

Although, for ease in comparing with other syngas production systems, space velocities at standard conditions have been used in the present studies, it is well known that contact time varies inversely with the “space velocity,” as that term is customarily used in chemical process descriptions, and is typically expressed as volumetric gas hourly space velocity in units of h⁻¹. The most preferred of the catalysts or catalyst beds disclosed herein have sufficient porosity, or sufficiently low resistance to gas flow, to permit the flow of reactant gases over the catalyst at a gas hourly space velocity (GHSV) of at least about 20,000 ⁻¹, which corresponds to a weight hourly space velocity (WHSV) of about 200 h⁻¹. Space velocities for the process (weight hourly space velocity), stated as normal liters of gas per kilogram of catalyst per hour, are from about 20,000 to about 100,000,000 NL/kg/h, preferably from about 50,000 to about 50,000,000 NL/kg/h. For monolith supported catalysts having densities ranging from about 0.5 kg/l to about 2.0 kg/l, a GHSV of about 10,000 to 200,000,000 h⁻¹ corresponds to about 20,000 to 100,000,000 normal liters of gas per kilogram of catalyst per hour (NL/kg/h), which is achievable at higher operating pressures. Under these operating conditions a rapid flow rate of reactant gases is preferably maintained sufficient to ensure a brief residence time on the catalyst (e.g., no more than 200 milliseconds, preferably under 50 milliseconds, and more preferably less than 10 milliseconds with respect to each portion of reactant gas in contact with the catalyst). In tests of representative catalysts (described below) in a reduced-scale short contact time reactor, the gas hourly space velocities (GHSV) obtained were as stated in the corresponding Tables.

### EXAMPLES

### Example 1

### 6.4% Mg_{2.5}LaRh₆O₁₃ on Alpha-alumina

Rhodium nitrate (0.325 g), magnesium nitrate (0.107 g) and lanthanum nitrate hydrate (0.072 g) were dissolved into 5 mL distilled water. 1 mL of the resulting clear solution was evaporated to dryness and the recovered solid was calcined in flowing (100 mL/min) pure oxygen in a gold boat at 600° C. for 4 hrs. XRD of the recovered solid confirmed formation of the hexagonal phase Mg_{2.5}LaRh₆O₁₃ in the form of very small crystallites, as determined from the very broad diffraction lines (data not shown). The remaining 4 mL of the original stock solution was then impregnated into 2 small (12 mm diameter) alumina monoliths and the solvent water was allowed to evaporate at room temperature. The monoliths were then calcined in flowing (100 mL/min) oxygen at 600° C. for 4 hrs and then flushed with nitrogen. The temperature was reduced to 400° C. and the impregnated monoliths were then reduced in flowing hydrogen at 400° C. for 30 mins. The monoliths were then cooled to room temperature in nitrogen, collected and tested as syngas production catalysts. The final loading of the monolith was 6.4 wt % Mg_{2.5}LaRh₆O₁₃. Results using this Mg_{2.5}LaRh₆O₁₃ hexagonal oxide phase on an alpha-alumina monolith support for syngas production in a 20 hr run using a 5-mm deep bed, according to the above-described Test Procedure, are shown in Table 1, and summarized in Table 5.

As an alternative to using the above-described support impregnation technique, a powdered ceramic material could instead be combined with the oxidizable/thermally decomposable metal salts. Some suitable ceramic materials are magnesium stabilized zirconia, alpha-alumina, cordierite, zirconia-toughened alumina oxide-bonded silicon carbide, mullite, lithium aluminum silicate, sialon, titanates, fused silica, magnesia, yttrium aluminum garnet, and boron nitride, and mixtures of those materials. The salts and the ceramic material are combined with a suitable solvent such that a thick slurry or a paste-like mixture is formed. This mixture is then shaped or extruded into the desired three-dimensional structure, such as a foam or monolith. After evaporation of the solvent a tortuous-path monolith catalyst is obtained. Preferred foams for use in the preparation of the supported monolith catalysts include those having from 30 to 150 pores per inch (12 to 60 pores per centimeter). Standard techniques for forming such supported catalyst structures are well known and have been described in the literature; for example, in Structured Catalysts and Reactors, A. Cybulski and J. A. Moulijn (Eds.), Marcel Dekker, Inc., 1998, p. 599-615 (Ch. 21, X. Xu and J. A. Moulijn, “Transformation of a Structured Carrier into Structured Catalyst”).

TABLE 1

| Pressure | | Temp. (° C.) | | GHSV | | % CH₄ | % CO | % H₂ | |
|---|---|---|---|---|---|---|---|---|---|
| (psig) | (kPa) | Pre-H | Cat-B | (h⁻¹) | CH₄:O₂ | Conv. | Sel. | Sel. | H₂:CO |
| 1.7 | 113 | 496 | 859 | 531,000 | 1.99 | 91 | 98 | 102 | 2.09 |
| 4.9 | 135 | 497 | 955 | 1,062,000 | 1.93 | 92 | 98 | 100 | 2.04 |
| 4.8 | 134 | 501 | 960 | 1,062,000 | 1.94 | 92 | 98 | 99 | 2.03 |
| 5.0 | 136 | 501 | 1015 | 1,079,00 | 1.84 | 95 | 98 | 99 | 2.03 |
| 1.7 | 113 | 497 | 860 | 531,000 | 1.98 | 92 | 108 | 94 | 2.11 |
| 1.7 | 113 | 500 | 890 | 539,000 | 1.87 | 97 | 98 | 104 | 2.11 |
| 1.7 | 113 | 503 | 952 | 549,000 | 1.80 | 100 | 98 | 102 | 2.09 |

### Example 2

### 6.1% Mg_{2.5}YbRh₆O₁₃ on PSZ

Rhodium chloride hydrate (0.07708 g), magnesium acetate (0.0256 g) and ytterbium nitrate hydrate (0.0215 g) were dissolved into 5 mL distilled water. The resulting solution was then impregnated into a (12 mm diameter, 10 mm length) PSZ monolith and the solvent water was allowed to evaporate on a hot plate. The monolith was then calcined in air at 700° C. for 4 hrs. After this treatment the metal mixtures was in the hexagonal phase as determined by powder XRD. The impregnated monolith was then reduced in flowing hydrogen at 500° C. for 3 hours. The monolith was then cooled to room temperature in nitrogen, collected and tested as a syngas production catalyst. The final loading of the monolith was 6.1 wt % Mg_{2.5}YbRh₆O₁₃. Results using this Mg_{2.5}YbRh₆O₁₃ hexagonal oxide phase on a PSZ monolith support for syngas production are shown in Table 2, and summarized in Table 5.

TABLE 2

| Pressure | | Temperature (° C.) | | GHSV | CH₄/O₂ | % CH₄ | % CO | % H₂ | H₂:CO |
|---|---|---|---|---|---|---|---|---|---|
| (Psig) | (kPa) | Pre-H | Cat-B | (h⁻¹) | (molar) | Conv. | Sel. | Sel. | (molar) |
| 5.3 | 138 | 160 | 688 | 178012 | 2 | 82 | 95 | 97 | 2.04 |
| 9.2 | 165 | 150 | 698 | 180250 | 2 | 82 | 95 | 95 | 2.00 |

### Example 3

### 6.1% Mg_{2.5}YbRh₆O₁₃ on ZrO2 Granules

Rhodium chloride hydrate (0.07708 g), magnesium acetate (0.0256 g) and ytterbium nitrate hydrate (0.0215 g) were dissolved into 5 mL distilled water. The resulting solution was then impregnated into ZrO₂ granules (an amount of granules equivalent to a 12 mm diameter×10 mm length volume) and the solvent water was allowed to evaporate on a hot plate. The granules were then calcined in air at 700° C. for 4 hrs. After this treatment the metal mixture was in the hexagonal phase as determined by powder XRD. The impregnated granules were then reduced in flowing hydrogen at 500° C. for 3 hours. The granules were then cooled to room temperature in nitrogen, collected and tested as syngas production catalysts. The final loading of the granules was 6.1 wt % Mg_{2.5}YbRh₆O₁₃. Results using this Mg_{2.5}YbRh₆O₁₃ hexagonal oxide phase supported on ZrO₂ support for syngas production are shown in Table 3, and summarized in Table 5.

TABLE 3

| Pressure | | Temperature (° C.) | | GHSV | CH₄/O₂ | % CH₄ | % CO | % H₂ | H₂:CO |
|---|---|---|---|---|---|---|---|---|---|
| (Psig) | (kPa) | Pre-H | Cat-B | (h⁻¹) | (molar) | Conv. | Sel. | Sel. | (molar) |
| 7.6 | 154 | 150 | 740 | 387,350 | 2 | 79 | 95 | 85 | 1.79 |
| 7.6 | 154 | 150 | 716 | 387,350 | 2 | 79 | 95 | 85 | 1.79 |
| 7.6 | 154 | 400 | 760 | 387,350 | 2 | 84 | 97 | 87 | 1.79 |

The following composition was prepared and tested under similar run conditions for comparison purposes:

### Comparative Example A

### 6.9% MgRh₂O₄ Spinel on Alpha-alumina

Rhodium nitrate hydrate (260 mg) and magnesium nitrate hydrate (100 mg) were dissolved in distilled water (4 mL). The resulting solution was evaporated at room temperature and pressure in the presence of two alumina monoliths (each 5×10 mm; 80 ppi) weighing 1.136 g. The alumina deposited nitrates were then calcined at 600° C. in pure oxygen for 4 hours to decompose to the spinel oxide phase as confirmed by powder XRD. After flushing well with nitrogen the monoliths were then further calcined at 400° C. in flowing hydrogen for 30 minutes. The final weight of the monoliths was 1.22 g for a spinel loading of 6.9 wt %. Results using this MgRh₂O₄ spinel on alpha-alumina monolith (5 mm deep catalyst bed) for syngas production in a 30 hr run are shown in Table 4, and summarized in Table 5.

TABLE 4

| Pressure | | Temp. (° C.) | | GHSV | | % CH₄ | % CO | % H₂ | |
|---|---|---|---|---|---|---|---|---|---|
| (psig) | (kPa) | Pre-H | Cat-B | (h⁻¹) | CH₄:O₂ | Conv. | Sel. | Sel. | H₂:CO |
| 2.8 | 121 | 498 | 850 | 531,000 | 2.0 | 94 | 100 | 101 | 2.03 |
| 3.0 | 122 | 503 | 939 | 546,000 | 1.9 | 99 | 100 | 99 | 1.97 |
| 6.9 | 149 | 496 | 899 | 796,000 | 2.0 | 92 | 103 | 100 | 1.94 |
| 7.4 | 152 | 497 | 938 | 809,000 | 1.9 | 98 | 101 | 101 | 1.92 |
| 8.2 | 158 | 497 | 1025 | 823,00 | 1.8 | 100 | 101 | 95 | 1.88 |
| 4.0 | 129 | 502 | 956 | 1,062,000 | 2.0 | 93 | 101 | 96 | 1.90 |
| 4.2 | 130 | 503 | 1015 | 1,079,000 | 1.9 | 98 | 99 | 94 | 1.89 |
| 4.4 | 130 | 503 | 1111 | 1,098,000 | 1.8 | 99 | 100 | 93 | 1.86 |

*:Experimental error: ±2%

TABLE 5
SUMMARY OF CATALYST COMPOSITIONS AND RUN TIMES

| | | | | | | CAT. | CAT. | WT. |
|---|---|---|---|---|---|---|---|---|
| | | | | | MAX. SV | WT. | DENS. | HR SV |
| EX. | COMPOSITION | SUPPORT | LENGTH | HRS. | (L/L/h) | (g.) | (g./ml) | (NL/kg/h) |
| 1 | 6.4% Mg_{2.5}LaRh₆O₁₃ | 80 ppi α-A₂O₃ | 5 mm | 20 | 1,700,000 | 1.846 | 3.267 | 520,000 |
| | | monolith | | 328 | 1,273,000 | | | 390,000 |
| 2 | 6.1% Mg_{2.5}YbRh₆O₁₃ | (MgO) PSZ | 10 mm | 5 | 180,250 | 0.7753 | 0.646 | 232,401 |
| | | monolith | | | | | | |
| 3 | 6.1% Mg_{2.5}YbRh₆O₁₃ | 35-50 mesh ZrO₂ | 10 mm | 7 | 387,350 | 2.16 | 1.6 | 242,094 |
| | | granules | | | | | | |

Comparative Example:

| | | | | | | | | |
|---|---|---|---|---|---|---|---|---|
| A | 6.9% MgRh₂O₄ spinel | 80 ppi α-A₂O₃ | 5 mm | 30 | 1,000,000 | 1.22 | 2.159 | 463,000 |
| | | monolith | | | | | | |

Process of Producing Syngas

A feed stream comprising a hydrocarbon feedstock and an oxygen-containing gas is contacted with one of the above-described Rh-containing catalysts in a reaction zone maintained at partial oxidation-promoting conditions of temperature, pressure and flow rate, effective to produce an effluent stream comprising carbon monoxide and hydrogen. Preferably a millisecond contact time reactor is employed. Several schemes for carrying out catalytic partial oxidation (CPOX) of hydrocarbons in a short contact time (i.e., millisecond range) reactor, and the major considerations involved in operating such reactors are known and have been described in the literature.

The hydrocarbon feedstock may be any gaseous hydrocarbon having a low boiling point, such as methane, natural gas, associated gas, or other sources of light hydrocarbons having from 1 to 5 carbon atoms. The hydrocarbon feedstock may be a gas arising from naturally occurring reserves of methane which contain carbon dioxide. Preferably, the feed comprises at least 50% by volume methane, more preferably at least 75% by volume, and most preferably at least 80% by volume methane.

The hydrocarbon feedstock is in the gaseous phase when contacting the catalyst. The hydrocarbon feedstock is contacted with the catalyst as a mixture with an oxygen-containing gas, preferably pure oxygen. The oxygen-containing gas may also comprise steam and/or CO₂ in addition to oxygen. Alternatively, the hydrocarbon feedstock is contacted with the catalyst as a mixture with a gas comprising steam and/or CO₂.

Preferably, the methane-containing feed and the oxygen-containing gas are mixed in such amounts to give a carbon (i.e., carbon in methane) to oxygen (i.e., atomic oxygen) ratio from about 1.25:1 to about 3.3:1, more preferably, from about 1.3:1 to about 2.2:1, and most preferably from about 1.5:1 to about 2.2:1, especially the stoichiometric ratio of 2:1.

The process is preferably operated at catalyst temperatures of from about 600° C. to about 1,200° C., preferably from about 700° C. to about 1,100° C. The hydrocarbon feedstock and the oxygen-containing gas are preferably pre-heated before contact with the catalyst.

The process is operated at atmospheric or superatmospheric pressures, the latter being preferred. The pressures may be from about 100 kPa (about 1 atmosphere) to about 12,500 kPa (about 125 atmospheres), preferably from about 130 kPa to about 10,000 kPa. An operating pressure above 2 atmospheres, which is advantageous for optimizing syngas production space-time yields, is highly preferred.

The hydrocarbon feedstock and the oxygen-containing gas are passed over the catalyst at any of a variety of space velocities. When employing a catalyst monolith or packed bed of divided catalyst, the surface area, depth of the catalyst bed, and gas flow rate (space velocity) are preferably adjusted to ensure the desired short contact time (i.e., less than 200 milliseconds, more preferably under 50 milliseconds, and still more preferably 20 milliseconds or less). Although not wishing to be bound by any particular theory, the inventors believe that, in the case of a methane reactant feed, the primary reaction catalyzed by the preferred catalysts described herein is the partial oxidation reaction of Equation 2, as described above in the background of the invention. Additionally, other chemical reactions may also occur to a lesser extent, catalyzed by the same catalyst composition. For example, in the course of syngas generation, intermediates such as CO₂+H₂O may occur as a result of the oxidation of methane, followed by a reforming step to produce CO and H₂. Also, particularly in the presence of carbon dioxide-containing feedstock or CO₂ intermediate, the reaction CH₄+CO₂→2CO+2H₂ (3) may also occur during the production of syngas. The product gas mixture emerging from the reactor is harvested and may be routed directly into any of a variety of applications. One such application for the CO and H₂ product stream is for producing higher molecular weight hydrocarbon compounds using Fischer-Tropsch technology.

While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The disclosures of all patents and publications cited herein are incorporated by reference.

What is claimed is:

1. A syngas catalyst comprising a hexagonal phase mixed metal oxide having the general formula (expressed as atomic ratios) M_{2.5}LnRh₆O₁₃, wherein M is a metal chosen from:
the Group II elements of the periodic table, and
the Group VIII transition metals that are capable of existing in a +2 oxidation state in said M_{2.5}LnRh₆O₁₃; and wherein Ln is a lanthanide rare earth element.

2. The catalyst of claim 1 wherein said M is chosen from Be, Mg, Ca, Sr and Ba.

3. The catalyst of claim 1 wherein M is chosen from Ti, V, Mn, Fe, Co, Ni, Cu, Zn, Nb, Pd, Cd and Ta.

4. The catalyst of claim 1 wherein said Ln is chosen from the group consisting of La, Yb, Sm and Ce.

5. The catalyst of claim 1 comprising said mixed metal oxide deposited on a refractory support.

6. The catalyst of claim 5 wherein said support is chosen from the group zirconia, partially stabilized zirconia, alumina, yttrium toughened alumina, cordierite, zirconia tetra aluminate, oxide-bonded silicon carbide, mullite, lithium aluminum silicate, titanates, fused silica, magnesia, yttrium aluminum garnet, silicon aluminum oxynitride, and boron nitride.

7. The catalyst of claim 5 comprising a monolith or a divided structure.

8. The catalyst of claim 7 wherein said divided structure is chosen from granules, beads, pills, pellets, cylinders, trilobes, extrudates, rounded shapes and regular or irregularly shaped particles.

9. The catalyst of claim 8 said divided unit is less than 10 millimeters in its longest dimension.

10. The catalyst of claim 1 comprising Mg_{2.5}LaRh₆O₁₃ deposited on a refractory support.

11. The catalyst of claim 1 comprising Mg_{2.5}YbRh₆O₁₃ deposited on a refractory support.

12. A method of making a supported syngas catalyst comprising a hexagonal phase mixed metal oxide having the general formula (expressed as atomic ratios) M_{2.5}LnRh₆O₁₃, wherein M is a metal chosen from the consisting of:
the Group II elements of the periodic table, and
the Group VIII transition metals that are capable of existing in a +2 oxidation state in said M_{2.5}LnRh₆O₁₃; and wherein Ln is a rare earth element, the method comprising:
depositing an oxidizable/thermally decomposable rhodium salt on a refractory support material;
depositing an oxidizable/thermally decomposable salt of a lanthanide element on said refractory support material;
depositing on said refractory support material an oxidizable/thermally decomposable salt of a metal chosen from the consisting of:
the Group II elements of the periodic table, and
the Group VIII transition metals that are capable of existing in a +2 oxidation state in said M_{2.5}LnRh₆O₁₃, to yield a coated support material;
calcining said coated support material in an oxidizing atmosphere such that said oxidizable/thermally decomposable salts become converted to a hexagonal oxide phase Mg_{2.5}LaRh₆O₁₃ as determined by X-ray diffraction analysis
cooling said coated support material while flushing with an inert gas; and
optionally, calcining said coated support material in a non-oxidizing atmosphere, to yield a supported catalyst that is active for catalyzing the net partial oxidation of C₁-C₅ hydrocarbons (e.g., methane) in the presence of oxygen in a short contact time reactor to a product mixture comprising CO and H₂.

13. The method of claim 12 further comprising forming said coated support material into a three-dimensional structure.

14. The method of claim 13 wherein said three-dimensional structure is chosen from monoliths, gauzes, honeycombs, foams, granules, beads, pills, pellets, cylinders, trilobes, extrudates and spheres.

15. The method of claim 12 further comprising forming said coated support material into a divided structure chosen from the group consisting of a granules, beads, pills, pellets, cylinders, trilobes, extrudates and spheres.

16. A catalyst prepared by a process comprising the method of claim 12.

17. A method of converting a light hydrocarbon and O₂ to a product mixture containing CO and H₂, the process comprising, in a reactor, passing a reactant gas mixture comprising said light hydrocarbon and O₂ over the catalyst of claim 1 such a product gas mixture comprising CO and H₂ is produced.

18. The method of claim 17 comprising maintaining a reactant gas pressure of at least 200 kPa (about 2 atmospheres) during said contacting.

19. The method of claim 17 comprising regulating the reactant gas pressure, temperature, hydrocarbon composition and the carbon:oxygen ratio of said reactant gas mixture such that the H₂:CO ratio of said product gas mixture is about 2:1.

20. A method of producing synthesis gas comprising:
contacting a reactant gas mixture comprising at least one C₁-C₅ hydrocarbon and O₂ with a catalytically effective amount of a catalyst comprising a hexagonal phase mixed metal oxide having the general formula (expressed as atomic ratios) M_{2.5}LnRh₆O₁₃, wherein M is a metal chosen from the consisting of:
the Group II elements of the periodic table,
the Group VIII transition metals that are capable of existing in a +2 oxidation state in said M_{2.5}LnRh₆O₁₃; and wherein Ln is a rare earth element, said mixed metal oxide supported on a refractory support; and maintaining catalytic partial oxidation reaction promoting conditions.

21. The method of claim 20 comprising mixing a C₁-C₅ hydrocarbon-containing feedstock and an O₂-containing feedstock to provide said reactant gas mixture.

22. The method of claim 20 wherein maintaining catalytic partial oxidation reaction promoting conditions includes maintaining a catalyst temperature not exceeding about 2,000° C.

23. The method of claim 20 comprising maintaining a catalyst temperature in the range of about 600-1,600° C. during said contacting.

24. The method of claim 23 comprising maintaining a catalyst temperature of about 700-1,100° C.

25. The method of claim 20 comprising maintaining said reactant gas mixture at a pressure in excess of 100 kPa during said contacting.

26. The method of claim 20 comprising maintaining said reactant gas mixture at a pressure up to about 32,000 kPa during said contacting.

27. The method of claim 26 comprising maintaining said reactant gas mixture at a pressure in the range of about 200-10,000 kPa during said contacting.

28. The method of claim 20 comprising mixing a methane-containing feedstock and an oxygen-containing feedstock to provide a reactant gas mixture having a carbon:oxygen ratio of about 1.5:1 to about 3.3:1.

29. The method of claim 28 wherein said mixing includes mixing said methane-containing feedstock and said oxygen-containing feedstock at a carbon:oxygen ratio of about 2:1.

30. The method of claim 20 wherein said mixing includes combining a methane-containing feedstock, an oxygen-containing feedstock and at least one of steam and CO₂.

31. The method of claim 20 wherein the C₁-C₅ hydrocarbon comprises at least about 80% methane by volume.

32. The method of claim 20 comprising preheating the reactant gas mixture before contacting the catalyst.

33. The method of claim 32 wherein said preheating comprises heating said reactant gas mixture to a temperature in the range of about 30-750° C.

34. The method of claim 20 comprising passing the reactant gas mixture over the catalyst at a gas hourly space velocity of about 20,000 to about 100,000,000 h⁻¹.

35. The method of claim 34 comprising passing the reactant gas mixture over the catalyst at a gas hourly space velocity of about 100,000 to about 25,000,000 h⁻¹.

36. The method of claim 20 comprising a catalyst/reactant gas mixture contact time of no more than about 200 milliseconds.

37. The method of claim 36 comprising a catalyst/reactant gas mixture contact time of less than 50 milliseconds.

38. The method of claim 37 comprising a catalyst/reactant gas mixture contact time of less than 20 milliseconds

39. The method of claim 38 comprising a catalyst/reactant gas mixture contact time of less than 10 milliseconds.

40. The method of claim 20 comprising retaining the catalyst in a fixed bed reaction zone.

41. The method of claim 20 comprising circulating said catalyst in a moving bed reaction zone.
